(19) United States
(12) Patent Application Publication
(10) Pub. No.: US 2006/0094420 A1
(43) Pub. Date: May 4, 2006

(54) Multi frequency band/multi air interface/multi spectrum reuse cluster size/multi cell size satellite radioterminal communicaitons systems and methods

(76) Inventor: Peter D. Karabinis, Cary, NC (US)

Correspondence Address: MYERS BIGEL SIBLEY & SAJOVEC, PO BOX 37428, RALEIGH, NC, 27627, US

(21) Appl. No.: 10/979,404

(22) Filed: Nov. 2, 2004

(51) Int. Cl. H04Q 7/20

(52) U.S. Cl. 455/427

(57) ABSTRACT

Satellite radioterminal communications systems, methods and components thereof, can use multiple frequency segments of at least one satellite frequency band, multiple air interfaces, multiple spectrum reuse cluster sizes and/or multiple geographic cell sizes. For example, a space-based component is configured to communicate with first radioterminals in first satellite cells over a first frequency segment of a satellite frequency band, such as a first frequency segment of a satellite L-band, and to communicate with second radioterminals in second satellite cells over a second frequency segment of the same or different satellite frequency band. The space-based component also may be configured to communicate with a first radioterminal over a first air interface and to communicate with the second radioterminals over a second air interface.

### FIELD OF THE INVENTION

This invention relates to radioterminal communications systems and methods, and more particularly to terrestrial and satellite radioterminal communications systems and methods.

### BACKGROUND OF THE INVENTION

Satellite communications systems and methods are widely used for radioterminal communications. Satellite radioterminal communications systems and methods generally employ at least one space-based component, such as one or more satellites, that is/are configured to wirelessly communicate with a plurality of satellite radioterminals.

A satellite radioterminal communications system or method may utilize a single antenna beam covering an entire area served by the system. Alternatively, in cellular satellite radioterminal communications systems and methods, multiple beams are provided, each of which can serve distinct geographical areas in the overall service region, to collectively serve an overall satellite footprint. Thus, a cellular architecture similar to that used in conventional terrestrial cellular/PCS radioterminal systems and methods can be implemented in cellular satellite-based systems and methods. The satellite typically communicates with radioterminals over a bidirectional communications pathway, with radioterminal communication signals being communicated from the satellite to the radioterminal over a downlink or forward link, and from the radioterminal to the satellite over an uplink or return link.

The overall design and operation of cellular satellite radioterminal systems and methods are well known to those having skill in the art, and need not be described further herein. Moreover, as used herein, the term “radioterminal” includes cellular and/or satellite radioterminals with or without a multi-line display; Personal Communications System (PCS) terminals that may combine a radioterminal with data processing, facsimile and/or data communications capabilities; Personal Digital Assistants (PDA) that can include a radio frequency transceiver and a pager, Internet/Intranet access, Web browser, organizer, calendar and/or a global positioning system (GPS) receiver; and/or conventional laptop and/or palmtop computers or other appliances, which include a radio frequency transceiver. As used herein, the term “radioterminal” also includes any other radiating user device/equipment/source that may have time-varying or fixed geographic coordinates, and may be portable, transportable, installed in a vehicle (aeronautical, maritime, or land-based), or situated and/or configured to operate locally and/or in a distributed fashion at any other location(s) on earth and/or in space. A “radioterminal” also may be referred to herein as a “radiotelephone,” “terminal” or “wireless user device”.

Terrestrial networks can enhance cellular satellite radioterminal system availability, efficiency and/or economic viability by terrestrially reusing at least some of the frequency bands that are allocated to cellular satellite radioterminal systems. In particular, it is known that it may be difficult for cellular satellite radioterminal systems to reliably serve densely populated areas, because the satellite signal may be blocked by high-rise structures and/or may not penetrate into buildings. As a result, the satellite spectrum may be underutilized or unutilized in such areas. The terrestrial reuse of at least some of the satellite system frequencies can reduce or eliminate this potential problem.

Moreover, the capacity of a hybrid system, comprising terrestrial and satellite-based connectivity and configured to terrestrially reuse at least some of the satellite-band frequencies, may be higher than a corresponding satellite-only system since terrestrial frequency reuse may be much denser than that of the satellite-only system. In fact, capacity may be enhanced where it may be mostly needed, i.e., in densely populated urban/industrial/commercial areas where the connectivity/signal(s) of a satellite-only system may be unreliable. As a result, a hybrid (satellite/terrestrial cellular) system that is configured to reuse terrestrially at least some of the frequencies of the satellite band may become more economically viable, as it may be able to serve more effectively and reliably a larger subscriber base.

One example of terrestrial reuse of satellite band frequencies is described in U.S. Pat. No. 5,937,332 to the present inventor Karabinis entitled Satellite Telecommunications Repeaters and Retransmission Methods, the disclosure of which is hereby incorporated herein by reference in its entirety as if set forth fully herein. As described therein, satellite telecommunications repeaters are provided which receive, amplify, and locally retransmit the downlink signal received from a satellite thereby increasing the effective downlink margin in the vicinity of the satellite telecommunications repeaters and allowing an increase in the penetration of uplink and downlink signals into buildings, foliage, transportation vehicles, and other objects which can reduce link margin. Both portable and non-portable repeaters are provided. See the abstract of U.S. Pat. No. 5,937,332.

Satellite radioterminals for a satellite radioterminal system or method having a terrestrial communications capability by terrestrially reusing at least some of the satellite frequency band and using substantially the same air interface for both terrestrial and satellite communications may be more cost effective and/or aesthetically appealing than other alternatives. Conventional dual band/dual mode radioterminal alternatives, such as the well known Thuraya, Iridium and/or Globalstar dual mode satellite/terrestrial radioterminals, duplicate some components (as a result of the different frequency bands and/or air interface protocols that are used between satellite and terrestrial communications), which can lead to increased cost, size and/or weight of the radioterminal. See U.S. Pat. No. 6,052,560 to the present inventor Karabinis, entitled Satellite System Utilizing a Plurality of Air Interface Standards and Method Employing Same.

U.S. Pat. No. 6,684,057, to coinventor Karabinis, and entitled Systems and Methods for Terrestrial Reuse of Cellular Satellite Frequency Spectrum, the disclosure of which is hereby incorporated herein by reference in its entirety as if set forth fully herein, describes that a satellite frequency can be reused terrestrially by an ancillary terrestrial network even within the same satellite cell, using interference cancellation techniques. In particular, a system according to some embodiments of U.S. Pat. No. 6,684,057 includes a space-based component that is configured to receive wireless communications from a first radiotelephone in a satellite footprint over a satellite radiotelephone frequency band, and an ancillary terrestrial network that is configured to receive wireless communications from a second radiotelephone in the satellite footprint over the satellite radiotelephone frequency band. The space-component also receives the wireless communications from the second-based radiotelephone in the satellite footprint over the satellite radiotelephone frequency band as interference, along with the wireless communications that are received from the first radiotelephone in the satellite footprint over the satellite radiotelephone frequency band. An interference reducer is responsive to the space-based component and to the ancillary terrestrial network that is configured to reduce the interference from the wireless communications that are received by the space-based component from the first radiotelephone in the satellite footprint over the satellite radiotelephone frequency band, using the wireless communications that are received by the ancillary terrestrial network from the second radiotelephone in the satellite footprint over the satellite radiotelephone frequency band.

Satellite radioterminal communications systems and methods that may employ terrestrial reuse of satellite frequencies are also described in Published U.S. patent application Ser. Nos. US 2003/0054760 to Karabinis, entitled Systems and Methods for Terrestrial Reuse of Cellular Satellite Frequency Spectrum; US 2003/0054761 to Karabinis, entitled Spatial Guardbands for Terrestrial Reuse of satellite Frequencies; US 2003/0054814 to Karabinis et al., entitled Systems and Methods for Monitoring Terrestrially Reused Satellite Frequencies to Reduce Potential Interference; US 2003/0054762 to Karabinis, entitled Multi-Band/Multi-Mode Satellite Radiotelephone Communications Systems and Methods; US 2003/0153267 to Karabinis, entitled Wireless Communications Systems and Methods Using Satellite-Linked Remote Terminal Interface Subsystems; US 2003/0224785 to Karabinis, entitled Systems and Methods for Reducing Satellite Feeder Link Bandwidth/Carriers In Cellular Satellite Systems; US 2002/0041575 to Karabinis et al., entitled Coordinated Satellite-Terrestrial Frequency Reuse; US 2002/0090942 to Karabinis et al., entitled Integrated or Autonomous System and Method of Satellite-Terrestrial Frequency Reuse Using Signal Attenuation and/or Blockage, Dynamic Assignment of Frequencies and/or Hysteresis; US 2003/0068978 to Karabinis et al., entitled Space-Based Network architectures for Satellite Radiotelephone Systems; US 2003/0143949 to Karabinis, entitled Filters for Combined Radiotelephone/GPS Terminals; US 2003/0153308 to Karabinis, entitled Staggered Sectorization for Terrestrial Reuse of Satellite Frequencies; and US 2003/0054815 to Karabinis, entitled Methods and Systems for Modifying Satellite Antenna Cell Patterns In Response to Terrestrial Reuse of satellite Frequencies, all of which are assigned to the assignee of the present invention, the disclosures of all of which are hereby incorporated herein by reference in their entirety as if set forth fully herein.

In particular, published U.S. patent application Ser. No. US 2003/0054762, cited above, describes in the Abstract thereof that satellite radiotelephone systems and communications methods include a space-based component that is configured to communicate with radiotelephones in a satellite footprint that is divided into satellite cells. The space-based component is configured to communicate with a first radiotelephone in a first satellite cell over a first frequency band and/or a first air interface, and to communicate with a second radiotelephone in the first or a second satellite cell over a second frequency band and/or a second air interface. An ancillary terrestrial network also is provided that is configured to communicate terrestrially with the first radiotelephone over substantially the first frequency band and/or substantially the first air interface, and to communicate terrestrially with the second radiotelephone over substantially the second frequency band and/or substantially the second air interface.

Finally, U.S. Pat. No. 5,073,900 to Mallinckrodt entitled Integrated Cellular Communications System provides a cellular communications system having both surface and satellite nodes which are fully integrated for providing service over large areas. A spread spectrum system is used with code division multiple access (CDMA) employing forward error correction coding (FECC) to enhance the effective gain and selectivity of the system. Multiple beam, relatively high gain antennas are disposed in the satellite nodes to establish the satellite cells, and by coupling the extra gain obtained with FECC to the high gain satellite node antennas, enough gain is created in the satellite part of the system such that a user need only use a small, mobile handset with a non-directional antenna for communications with both ground nodes and satellite nodes. User position information is also available. A digital data interleaving feature reduces fading. As also noted in Column 6, lines 1-12 of this patent, a significant advantage of the invention is that by the use of spread spectrum multiple access, adjacent cells are not required to use different frequency bands. All ground-user links utilize the same two frequency sub-bands (OG 28, IG 34) and all satellite-user links use the same two frequency sub-bands (OS 30, IS 36). This obviates an otherwise complex and restrictive frequency coordination problem of ensuring that frequencies are not reused within cells closer than some minimum distance to one another (as in the FM approach), and yet provides for a hierarchical set of cell sizes to accommodate areas of significantly different subscriber densities.

### SUMMARY OF THE INVENTION

Some embodiments of the present invention provide satellite radioterminal communications systems, methods and components thereof, that can use combinations and subcombinations of multiple band segments of at least one satellite frequency band, multiple air interfaces, multiple spectral reuse cluster sizes and multiple geographic cell sizes. More specifically, satellite radioterminal communications systems according to some embodiments of the present invention include a space-based component that is configured to communicate with a plurality of first radioterminals in a plurality of first satellite cells over a first band segment of a satellite frequency band, such as a first band segment of satellite L-band, and to communicate with a plurality of second radioterminals in a plurality of second satellite cells over a second band segment of the same and/or different satellite frequency band. In other embodiments, the space-based component is further configured to communicate with the plurality of first radioterminals in the first plurality of satellite cells over a first air interface and to communicate with the plurality of second radioterminals in the plurality of second satellite cells over a second air interface. In still other embodiments, the space-based component is further configured to communicate with the plurality of first radioterminals in the plurality of first satellite cells using a first spectrum reuse cluster size and to communicate with the plurality of second radioterminals in the plurality of second satellite cells using a second spectrum reuse cluster size. In yet other embodiments, the space-based component is further configured to communicate with the plurality of first radioterminals in the plurality of first satellite cells having a first geographic cell size and to communicate with the plurality of second radioterminals in the plurality of second satellite cells having a second geographic cell size.

In other embodiments of the present invention, an ancillary terrestrial network is provided that is configured to communicate terrestrially with at least some of the plurality of first radioterminals over substantially the first band segment of the satellite frequency band. The ancillary terrestrial network may be further configured to communicate terrestrially with at least some of the plurality of first radioterminals over substantially the first air interface. The ancillary terrestrial network may be further configured to communicate terrestrially with at least some of the plurality of first radioterminals in a plurality of first ancillary terrestrial network cells using a third spectrum reuse cluster size. In yet other embodiments, the ancillary terrestrial network is also configured to communicate terrestrially with at least some of the plurality of second radioterminals in a plurality of second ancillary terrestrial network cells using a fourth spectrum reuse cluster size.

In any of the above-described embodiments, the plurality of first satellite cells and the plurality of second satellite cells may at least partially overlap geographically. Moreover, in any of the above-described embodiments, either the first spectrum reuse cluster size or the second spectrum reuse cluster size may be equal to one. Moreover, in any of the above-described embodiments, either the first spectrum reuse cluster size or the third spectrum reuse cluster size may be equal to one, and either the second spectrum reuse cluster size or the fourth spectrum reuse cluster size may be equal to one. Additionally, in any of the above-described embodiments, the first band segment of the satellite frequency band and the second band segment of the same and/or different satellite frequency band may overlap partially but not fully. Finally, in any of the above embodiments, the plurality of first satellite cells and the plurality of second satellite cells, and corresponding portions of the ancillary terrestrial network, may be associated with respective first and second wireless network operators.

Embodiments of the present invention may be combined with a first terrestrial wireless network that is configured to communicate terrestrially with at least some of the plurality of first radioterminals over a terrestrial wireless network frequency band. Moreover, in other embodiments, the terrestrial cellular network is configured to communicate terrestrially with at least some of the plurality of first radioterminals over substantially the first air interface. Embodiments of the present invention also may be combined with a second terrestrial wireless network that is configured to communicate terrestrially with at least some of the plurality of second radioterminals over a terrestrial wireless network frequency band. Moreover, in other embodiments, the second terrestrial wireless network is configured to communicate terrestrially with at least some of the plurality of second radioterminals over substantially the second air interface.

Accordingly, some embodiments of the present invention allow a satellite radiotelephone communications system to provide space-based and terrestrial communications systems using satellite frequencies, for operation with multiple terrestrial cellular radioterminal communications systems. Embodiments of the present invention may also allow an existing satellite radioterminal communications system to be expanded to operate with multiple different terrestrial wireless systems.

Finally, embodiments of the present invention have been described above primarily with respect to space-based components. However, analogous ancillary terrestrial components and methods also may be provided.

### BRIEF DESCRIPTION OF THE DRAWINGS

FIGS. 1-4 are schematic diagrams illustrating satellite radioterminal communications systems and operational methods thereof, according to various embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that although the terms first and second are used herein to describe various elements, these elements should not be limited by these terms. These terms are only used to distinguish one element from another element. Thus, a first element below could be termed a second element, and similarly, a second element may be termed a first element without departing from the teachings of the present invention. As used herein, the term “and/or” includes any and all combinations of one or more of the associated listed items. The symbol “/” is also used as a shorthand notation for “and/or”.

Moreover, as used herein, the term “substantially”, as applied to band segments, means that the band segments substantially overlap, but that there may be some areas of non-overlap, for example at the band segment ends. Moreover, the term “substantially”, as applied to air interfaces, means that the air interfaces are similar but need not be identical. Some changes may be made to one air interface (e.g., a satellite air interface) relative to another (i. e., a terrestrial air interface) to account for different characteristics that may exist between the terrestrial and satellite communications environments. For example, a different vocoder rate may be used for satellite communications compared to the vocoder rate that may be used for terrestrial communications (e.g., for terrestrial communications, voice may be compressed (“vocoded”) to approximately 9 to 13 kbps, whereas for satellite communications a vocoder rate of 2 to 4 kbps, for example, may be used); a different forward error correction coding, different interleaving depth, and/or different spread-spectrum codes may also be used, for example, for satellite communications compared to the coding, interleaving depth, and/or spread spectrum codes (e.g., Walsh codes, long codes, and/or frequency hopping codes) that may be used for terrestrial communications.

Multi-band/multi-mode satellite radioterminal communications systems and methods according to some embodiments of the present invention may be used when a satellite footprint or service area spans a geographic area in which two or more terrestrial radioterminal systems (terrestrial wireless network operators) are present, to add spaced-based communications capability to two or more terrestrial wireless networks. Within a geographic area that is covered by a given terrestrial wireless system, embodiments of the invention can provide additional capacity and/or extended services using a space-based component and/or an ancillary terrestrial network, using substantially the same band segment and/or air interface as the terrestrial radiotelephone system. Thus, different geographic regions corresponding to different wireless radioterminal communications systems and methods according to embodiments of the invention may use different band segments of a satellite frequency band, such as L-band, and may use different air interfaces for compatibility with the terrestrial wireless systems that are located within the different geographic areas. There also may be other scenarios wherein it may be desired for a single satellite radioterminal communications system/method to employ different band segments, and potentially different air interfaces over the same and/or different geographic regions thereof.

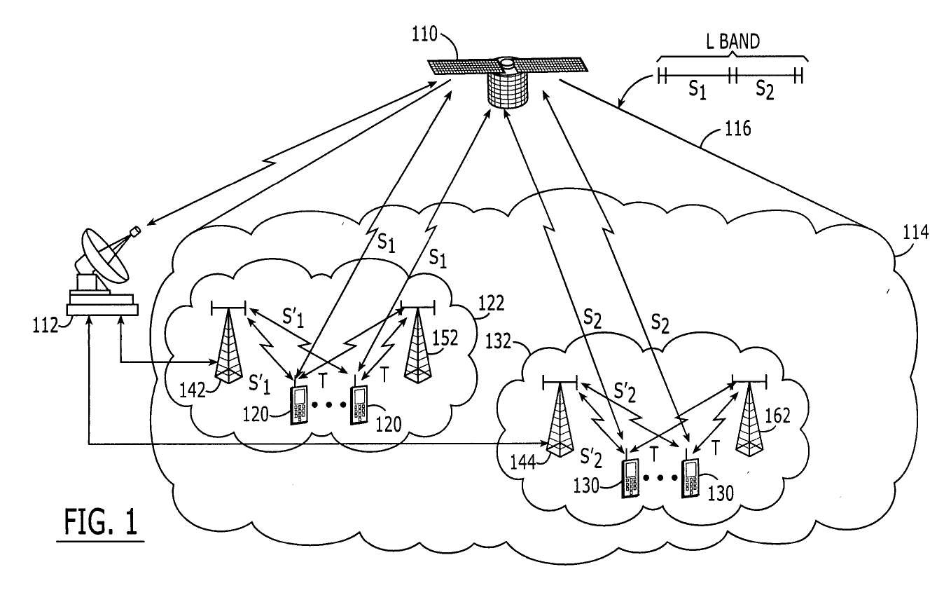

FIG. 1 is a schematic diagram of satellite radioterminal communications systems and methods according to some embodiments of the present invention. As shown in FIG. 1, these embodiments of satellite radioterminal communications systems and methods include a space-based component that can comprise one or more satellites 110 and associated satellite gateway(s) 112 and other ground support components. The satellite 110 is configured to communicate with a plurality of radioterminals over a satellite footprint 114 using a satellite frequency band 116, shown in FIG. 1 as L-band. It will be understood that in other embodiments, S-band or other satellite bands may be used.

As also shown in FIG. 1, the satellite 110 is configured to communicate with a plurality of first radioterminals 120 in a plurality of first satellite cells 122 in the satellite footprint 114 over a first band segment S₁ of the satellite frequency band (e.g., L-band), and to communicate with a plurality of second radioterminals 130 in a plurality of second satellite cells 132 in the satellite footprint 114 over a second band segment S₂ of the satellite frequency band. Thus, band segmentation of a satellite band, such as L-band, may be used to allow satellite radioterminal communications with radioterminals in satellite cells within the satellite footprint 114. In some embodiments, the bandwidth of the first band segment is the same as the bandwidth of the second band segment. However, in other embodiments, the bandwidths may be different.

As also shown in FIG. 1, an ancillary terrestrial network also may be provided, including a plurality of ancillary terrestrial components 142, 144. The ancillary terrestrial network is configured to communicate terrestrially with at least some of the plurality of first radioterminals 120 over substantially the first band segment, S′₁, of the satellite frequency band (the band segment S′₁ may be identical to the band segment S₁ or it may be a subset thereof). The ancillary terrestrial network also includes at least one ancillary terrestrial component 144 that is configured to communicate terrestrially with at least some of the plurality of second radioterminals 130 over substantially the second band segment, S′₂ (the band segment S′₂ may be identical to the band segment S₂ or it may be a subset thereof). Finally, at least some of the radioterminals 120/130 also may be configured to communicate with terrestrial wireless infrastructure of one or more terrestrial networks. As used herein, terrestrial wireless networks include terrestrial cellular, PCS, Wi Fi, WiMAX and/or other terrestrial wireless networks. Thus, at least some of the first radioterminals 120 may communicate with a first terrestrial wireless network base station and/or access point 152 (as shown in FIG. 1) and/or with (not explicitly shown in FIG. 1) a second terrestrial wireless network base station and/or access point 162 and at least some of the second radioterminals 130 may communicate with the second terrestrial wireless network base station and/or access point 162 (as shown in FIG. 1) and/or with (not explicitly shown in FIG. 1) the first terrestrial wireless network base station and/or access point 152. The base stations and/or access points 152 and 162 may belong to the same terrestrial wireless network or to different terrestrial wireless networks, and communications may take place using a terrestrial frequency band T (licensed or unlicensed), which, as noted above, can include cellular, PCS, Wi Fi, WiMAX and/or other terrestrial wireless frequencies.

It will be understood by those having skill in the art that although a plurality of first satellite cells 122 and second satellite cells 132 are shown in FIG. 1, three or more groupings of satellite cells also may be provided. Moreover, although a single ancillary terrestrial component 142, 144 is shown in each respective grouping of satellite cells 122, 132, larger numbers of ancillary terrestrial components generally will be provided. Large numbers of radioterminals 120, 130 also generally may be provided and large numbers of terrestrial base stations and/or access points 152, 162 also may be provided. More than one satellite 110 and more than one satellite gateway 112 also may be provided. Moreover, although not illustrated in FIG. 1, the plurality of first satellite cells 122 and the plurality of second satellite cells 132 may at least partially overlap geographically. Finally, although not shown in FIG. 1, the first band segment S₁ of the satellite frequency band such as L-band and the second band segment S₂ of the satellite frequency band such as L-band may overlap partially but not fully. It will also be understood by those having skill in the art that although the first band segment S₁ and the second band segment S₂ have been illustrated as belonging to a common satellite band, such as the L-band, the two band segments (S₁, S₂) may comprise frequencies of the same and/or different satellite frequency bands such as, for example, S₁ may comprise frequencies of the L-band while S₂ may comprise frequencies of the L-band and/or an S-band.

Band segmentation may be used according to some embodiments of the present invention to allow two terrestrial wireless network operators to provide space-based communications and terrestrial reuse of space-based frequencies within their networks. Thus, the respective pluralities 122 and 132 of satellite cells may be associated with first and second terrestrial wireless network operators and the respective first and second pluralities of ancillary terrestrial components 142 and 144, respectively, also may be associated with the first and second terrestrial wireless network operators, as may be the respective first and second terrestrial wireless base stations and/or access points 152 and 162.

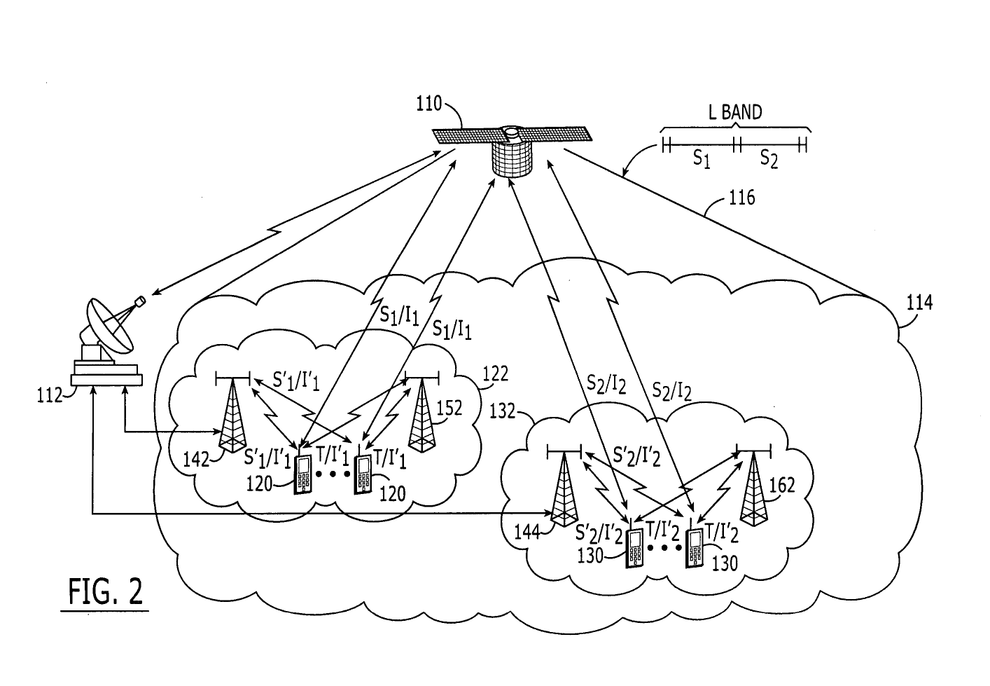

FIG. 2 is a schematic diagram of satellite radiotelephone systems and methods according to other embodiments of the present invention. FIG. 2 is similar to FIG. 1 except that it also provides terrestrial and space-based communications for a given radioterminal using a substantially common air interface. Thus, as shown in FIG. 2, communications between the satellite 110 and the plurality of first radioterminals 120 occurs over a first satellite band segment S₁ and a first air interface I₁ and space-based communications with the plurality of second radioterminals 130 takes place over a second band segment S₂ and a second air interface I₂. Moreover, in some embodiments of the present invention as also shown in FIG. 2, communications between at least some of the plurality of first radioterminals 120 and the first ancillary terrestrial component 142 takes place using substantially the first air interface I′₁ and communications between at least some of the plurality of second radioterminals 130 and the second ancillary terrestrial component 144 takes place over substantially the second air interface I′₂. Moreover, in yet other embodiments of the present invention, as also illustrated in FIG. 2, terrestrial communications between at least some of the first radioterminals 120 and a first terrestrial base station and/or access point 152 may take place using substantially the first air interface I′₁, and terrestrial communications between at least some of the plurality of second radioterminals 130 and a second terrestrial base station and/or access point 162 may also occur using substantially the second air interface I′₂. Thus, as shown in FIG. 2, when integrating space-based and/or ancillary terrestrial communications with the conventional terrestrial wireless communications that are provided by a terrestrial wireless network operator, substantially the same air interface may be used to provide a seamless or near-seamless air interface environment for radioterminal users.

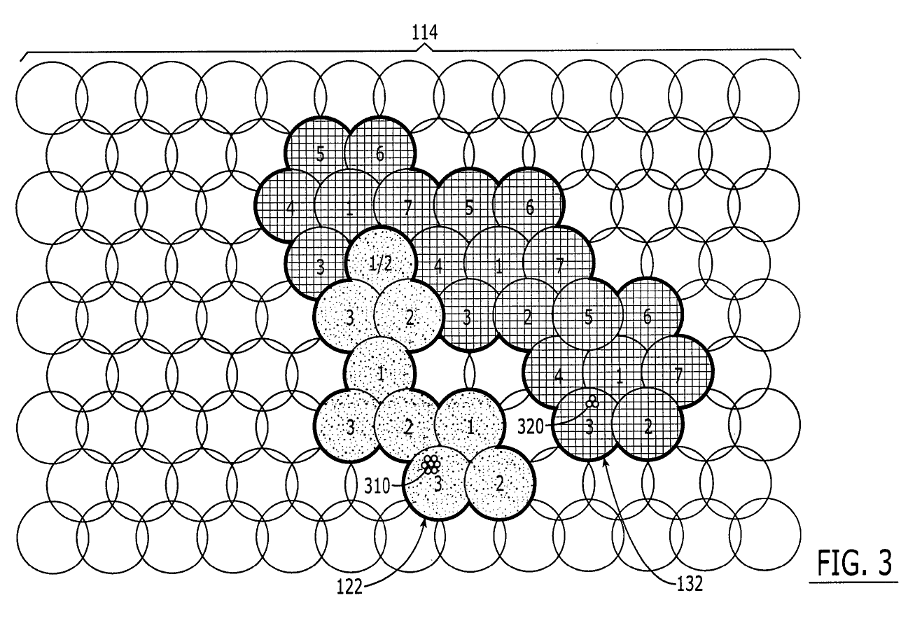

FIG. 3 is a schematic diagram of satellite radiotelephone systems and methods according to yet other embodiments of the invention. As shown in FIG. 3, in some embodiments of the present invention, the space-based component may be configured to communicate with the plurality of first radioterminals in the plurality of first satellite cells 122 using a first spectrum reuse cluster size, such as a 3-cell spectrum reuse cluster size, and to communicate with a plurality of second radioterminals in a plurality of second satellite cells 132 using a second spectrum reuse cluster size, such as a 7-cell spectrum reuse cluster size. In particular, when a GSM protocol and/or other Time Division Multiplex/Multiple Access (TDM/TDMA) protocol is used, a 7-cell frequency reuse pattern may be desirable, whereas with CDMA and/or other protocols a 3-cell reuse pattern may be desirable. Accordingly, the needs or desires of different wireless network operators that use different wireless protocols may be accommodated.

It will be understood by those having skill in the art that at least one of the spectrum reuse cluster sizes may be equal to one. As used herein a spectrum reuse cluster size of one may be embodied by using immediate frequency reuse between cells of a satellite footprint, sectors of an ancillary terrestrial component and/or between adjacent ancillary terrestrial components. Multiuser detection principles and/or other intra-/inter-cell, intra-/inter-sector, and/or intra-/inter-base station interference mitigation/cancellation techniques that are known to those having skill in the art may be used to provide mitigation and/or cancellation of interference resulting from any given frequency reuse methodology.

It will also be understood by those having skill in the art that, for ease of explanation, the radioterminals 120, 130, ancillary terrestrial components 142, 144 and terrestrial wireless networks 152, 162 are not illustrated in FIG. 3. Moreover, in some embodiments of the present invention, different spectrum reuse cluster size may be combined with different band segments to combine embodiments of FIGS. 1 and 2. Moreover, in yet other embodiments, different spectrum reuse cluster sizes of FIG. 3 may be combined with substantially the same air interfaces as shown in FIG. 2 or may be combined with segmented bands and substantially the same air interfaces as shown in FIG. 2. Accordingly, the needs or desires of different terrestrial wireless operators may be accommodated by providing different spectrum reuse cluster sizes for satellite cells that are provided by a space-based component according to embodiments of the present invention.

Moreover, as also shown in FIG. 3, an ancillary terrestrial network may be provided that is configured to communicate terrestrially with at least some of the plurality of first radioterminals in the first plurality of ancillary terrestrial network cells 310 using a third spectrum reuse cluster size, and to communicate with at least some of the plurality of second radioterminals in a plurality of second ancillary terrestrial network cells 320 using a fourth spectrum reuse cluster size. Thus, within a given satellite cell, the ancillary terrestrial network need not use the same spectrum reuse cluster size as employed by the portion of the space-based network that incorporates the given satellite cell. Rather, different spectrum reuse cluster sizes may be used by a plurality of satellite cells and an ancillary terrestrial network that is within a geographic area spanned by one or more of the plurality of satellite cells. Finally, although 7 and 3-cell spectrum reuse cluster sizes are shown in FIG. 3, other spectrum reuse cluster sizes, incorporating any integer number of cells in the frequency reuse cluster size, may be used, including embodiments wherein the first and/or second spectrum reuse cluster size is equal to one or any other number, the first and/or third spectrum reuse cluster size is equal to one or any other number, or the second and/or fourth spectrum reuse cluster size is equal to one or any other number.

It will also be understood by those having skill in the art that embodiments of FIG. 3 may be combined with embodiments of FIG. 1 and/or FIG. 2. Thus, the different spectrum reuse cluster size of the satellite cells and/or ancillary terrestrial network cells may be combined with the different band segments of a satellite frequency band shown in FIG. 1. Moreover, substantially the same air interfaces as shown in FIG. 2 also may be provided either with or without using the different satellite band segments.

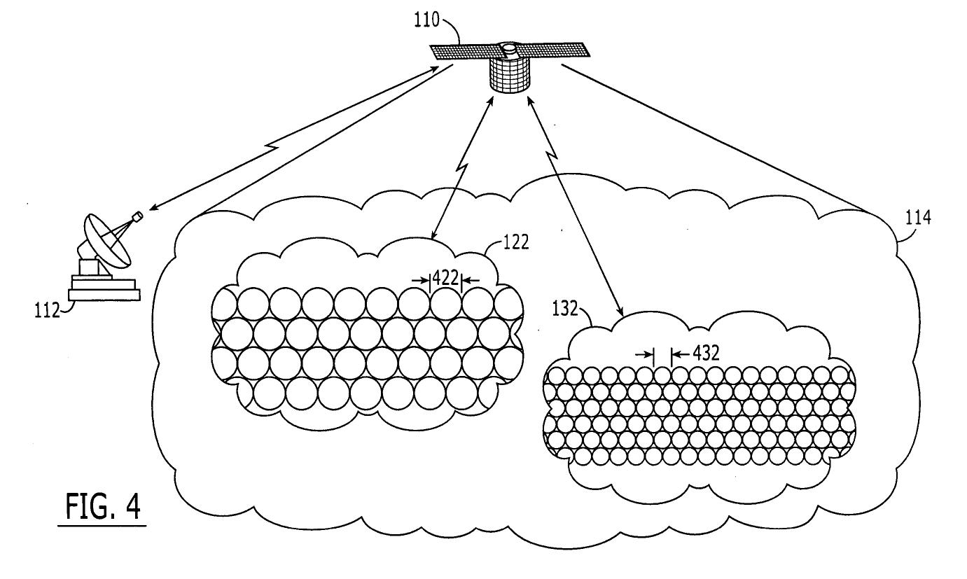

FIG. 4 illustrates other embodiments of the present invention wherein the space-based component 110 is configured to communicate with the plurality of first radioterminals in the plurality of first satellite cells 122 having a first geographic cell size 422 and to communicate with the plurality of second radioterminals in the plurality of second satellite cells 132 having a second geographic cell size 432. Thus, the space-based component can provide different geographic cell sizes (on the forward and/or return service links) to accommodate the needs of one or more terrestrial wireless network operators and/or the needs of one or more satellite operators/service providers. It will be understood that, for ease of explanation, the radioterminals, ancillary terrestrial components and terrestrial wireless base stations have not been illustrated in FIG. 4. Moreover, as shown in FIGS. 3 and 4, the number of satellite cells in the plurality of first satellite area cells 122 and the number of satellite cells in the second plurality of satellite cells 132 may be different. However, in other embodiments, they may be the same. It will also be understood that the geographic area spanned by the first satellite area cells 122 may overlap, substantially or at least some, with the geographic area spanned by the second satellite area cells 132. In other embodiments the geographic area spanned by the first satellite area cells 122 may not overlap with the geographic area spanned by the second satellite area cells 132.

It also will be understood that embodiments of FIG. 4 may be combined with embodiments of FIG. 1 to provide variable cell size and band segmentation. Moreover, embodiments of FIG. 4 may also be combined with embodiments of FIG. 2 to provide variable cell size and substantially common air interfaces, or variable cell size, band segmentation and substantially common air interfaces. Finally, embodiments of FIG. 4 also may be combined with embodiments of FIG. 3 to provide variable cell size and variable spectrum reuse cluster size and may also be combined with embodiments of FIGS. 1 and/or 2 to also provide band segmentation and/or a substantially common air interface.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A satellite radioterminal communications system comprising:
a space-based component that is configured to communicate with a plurality of first radioterminals in a plurality of first satellite cells over a first band segment of a satellite frequency band and to communicate with a plurality of second radioterminals in a plurality of second satellite cells over a second band segment of the same and/or different satellite frequency band.

2. A satellite radioterminal communications system according to claim 1 wherein the space-based component is further configured to communicate with the plurality of first radioterminals in the plurality of first satellite cells over a first air interface and to communicate with the plurality of second radioterminals in the plurality of second satellite cells over a second air interface.

3. A satellite radioterminal communications system according to claim 2 wherein the space-based component is further configured to communicate with the plurality of first radioterminals in the plurality of first satellite cells using a first spectrum reuse cluster size and to communicate with the plurality of second radioterminals in the plurality of second satellite cells using a second spectrum reuse cluster size.

4. A satellite radioterminal communications system according to claim 2 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

5. A satellite radioterminal communications system according to claim 3 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

6. A satellite radioterminal communications system according to claim 1 wherein the space-based component is further configured to communicate with the plurality of first radioterminals in the plurality of first satellite cells using a first spectrum reuse cluster size and to communicate with the plurality of second radioterminals in the plurality of second satellite cells using a second spectrum reuse cluster size.

7. A satellite radioterminal communications system according to claim 6 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

8. A satellite radioterminal communications system according to claim 1 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

9. A satellite radioterminal communications system according to claim 1 further comprising:
an ancillary terrestrial network that is configured to communicate terrestrially with at least some of the plurality of first radioterminals over substantially the first band segment of the satellite frequency band.

10. A satellite radioterminal communications system according to claim 2 further comprising:
an ancillary terrestrial network that is configured to communicate terrestrially with at least some of the plurality of first radioterminals over substantially the first air interface.

11. A satellite radioterminal communications system according to claim 3 further comprising:
an ancillary terrestrial network that is configured to communicate terrestrially with at least some of the plurality of first radioterminals in a plurality of first ancillary terrestrial network cells using a third spectrum reuse cluster size.

12. A satellite radioterminal communications system according to claim 1 further comprising:
an ancillary terrestrial network that is configured to communicate terrestrially with at least some of the plurality of first radioterminals over substantially the first band segment of the satellite frequency band and with at least some of the plurality of second radioterminals over substantially the second band segment of the satellite frequency band.

13. A satellite radioterminal communications system according to claim 2 further comprising:
an ancillary terrestrial network that is configured to communicate terrestrially with at least some of the plurality of first radioterminals over substantially the first air interface and with at least some of the plurality of second radioterminals over substantially the second air interface.

14. A satellite radioterminal communications system according to claim 3 further comprising:
an ancillary terrestrial network that is configured to communicate terrestrially with at least some of the plurality of first radioterminals in a plurality of first ancillary terrestrial network cells using a third spectrum reuse cluster size and to communicate terrestrially with at least some of the plurality of second radioterminals in a plurality of second ancillary terrestrial network cells using a fourth spectrum reuse cluster size.

15. A satellite radioterminal communications system according to claim 1 wherein the satellite frequency band is L-band and/or S-band.

16. A satellite radioterminal communications system according to claim 1 wherein the plurality of first satellite cells and the plurality of second satellite cells at least partially overlap geographically.

17. A satellite radioterminal communications system according to claim 3 wherein the first spectrum reuse cluster size or the second spectrum reuse cluster size is equal to one.

18. A satellite radioterminal communications system according to claim 11 wherein the first spectrum reuse cluster size or the third spectrum reuse cluster size is equal to one.

19. A satellite radioterminal communications system according to claim 1 wherein the first band segment of the satellite frequency band and the second band segment of the satellite frequency band overlap partially but not fully.

20. A satellite radioterminal communications system according to claim 1 wherein the plurality of first satellite cells and the plurality of second satellite cells are associated with respective first and second wireless network operators.

21. A satellite radioterminal communications system according to claim 12 wherein the ancillary terrestrial network comprises a first ancillary terrestrial component that is configured to communicate with at least some of the plurality of first radioterminals over substantially the first band segment of the satellite frequency band, and a second ancillary terrestrial component that is configured to communicate with at least some of a plurality of second radioterminals over substantially the second band segment of a satellite frequency band.

22. A satellite radioterminal communications system according to claim 21 wherein the plurality of first satellite cells and the first ancillary terrestrial component is associated with a first wireless network operator and wherein the plurality of second satellite cells and the second ancillary terrestrial component is associated with a second wireless network operator.

23. A satellite radioterminal communications system according to claim 9 in combination with a terrestrial wireless network that is configured to communicate terrestrially with at least some of the plurality of first radioterminals over a terrestrial wireless network frequency band.

24. A satellite radioterminal communications system according to claim 10 in combination with a terrestrial wireless network that is configured to communicate terrestrially with at least some of the plurality of first radioterminals over a terrestrial wireless network frequency band and over substantially the first air interface.

25. A satellite radioterminal communications system comprising:
a space-based component that is configured to communicate with a plurality of first radioterminals in a plurality of first satellite cells using a first spectrum reuse cluster size and to communicate with a plurality of second radioterminals in a plurality of second satellite cells using a second spectrum reuse cluster size.

26. A satellite radioterminal communications system according to claim 25 wherein the space-based component is further configured to communicate with the plurality of first radioterminals in the plurality of first satellite cells over a first air interface and to communicate with the plurality of second radioterminals in the plurality of second satellite cells over a second air interface.

27. A satellite radioterminal communications system according to claim 26 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

28. A satellite radioterminal communications system according to claim 25 wherein the space-based component is further configured to communicate with the plurality of first radioterminals in the plurality of first satellite cells having a first geographic cell size and to communicate with the plurality of second radioterminals in the plurality of second satellite cells having a second geographic cell size.

29. A satellite radioterminal communications system according to claim 25 further comprising:
an ancillary terrestrial network that is configured to communicate terrestrially with at least some of the plurality of first radioterminals in a plurality of first ancillary terrestrial network cells using a third spectrum reuse cluster size.

30. A satellite radioterminal communications system according to claim 26 further comprising:
an ancillary terrestrial network that is configured to communicate terrestrially with at least some of the plurality of first radioterminals over substantially the first air interface.

31. A satellite radioterminal communications system according to claim 25 further comprising:
an ancillary terrestrial network that is configured to communicate terrestrially with at least some of the plurality of first radioterminals in a plurality of first ancillary terrestrial network cells using a third spectrum reuse cluster size and to communicate terrestrially with at least some of the plurality of second radioterminals in a plurality of second ancillary terrestrial network cells using a fourth spectrum reuse cluster size.

32. A satellite radioterminal communications system according to claim 26 further comprising:
an ancillary terrestrial network that is configured to communicate terrestrially with at least some of the plurality of first radioterminals over substantially the first air interface and with at least some of the plurality of second radioterminals over substantially the second air interface.

33. A satellite radioterminal communications system according to claim 25 wherein the plurality of first satellite cells and the plurality of second satellite cells at least partially overlap geographically.

34. A satellite radioterminal communications system according to claim 25 wherein the first spectrum reuse cluster size or the second spectrum reuse cluster size is equal to one.

35. A satellite radioterminal communications system according to claim 31 wherein the first spectrum reuse cluster size or the third spectrum reuse cluster size is equal to one.

36. A satellite radioterminal communications system according to claim 25 wherein the plurality of first satellite cells and the plurality of second satellite cells are associated with respective first and second wireless network operators.

37. A satellite radioterminal communications system according to claim 31 wherein the plurality of first satellite cells and the plurality of first ancillary terrestrial network cells are associated with a first wireless network operator and wherein the plurality of second satellite cells and the plurality of second ancillary terrestrial network cells are associated with a second wireless network operator.

38. A satellite radioterminal communications system according to claim 31 in combination with a terrestrial wireless network that is configured to communicate terrestrially with at least some of the plurality of first radioterminals over a terrestrial wireless network frequency band.

39. A satellite radioterminal communications system according to claim 32 in combination with a terrestrial wireless network that is configured to communicate terrestrially with at least some of the plurality of first radioterminals over a terrestrial wireless network frequency band and over substantially the first air interface.

40. A satellite radioterminal communications system comprising:
a space-based component that is configured to communicate with a plurality of first radioterminals in a plurality of first satellite cells having a first geographic cell size over a first air interface and to communicate with a plurality of second radioterminals in a plurality of second satellite cells having a second geographic cell size over a second air interface.

41. A satellite radioterminal communications system according to claim 40 further comprising:
an ancillary terrestrial network that is configured to communicate terrestrially with at least some of the plurality of first radioterminals over substantially the first air interface.

42. A satellite radioterminal communications system according to claim 40 further comprising:
an ancillary terrestrial network that is configured to communicate terrestrially with at least some of the plurality of first radioterminals over substantially the first air interface and with at least some of the plurality of second radioterminals over substantially the second air interface.

43. A satellite radioterminal communications system according to claim 40 wherein the plurality of first satellite cells and the plurality of second satellite cells at least partially overlap geographically.

44. A satellite radioterminal communications system according to claim 40 wherein the plurality of first satellite cells and the plurality of second satellite cells are associated with respective first and second wireless network operators.

45. A satellite radioterminal communications system according to claim 42 wherein the ancillary terrestrial network comprises a first ancillary terrestrial component that is configured to communicate with at least some of the plurality of first radioterminals over substantially the first air interface, and a second ancillary terrestrial component that is configured to communicate with at least some of a plurality of second radioterminals over substantially the second air interface.

46. A satellite radioterminal communications system according to claim 45 wherein the plurality of first satellite cells and the first ancillary terrestrial component is associated with a first wireless network operator and wherein the plurality of second satellite cells and the second ancillary terrestrial component is associated with a second wireless network operator.

47. A satellite radioterminal communications system according to claim 40 in combination with a terrestrial wireless network that is configured to communicate terrestrially with at least some of the plurality of first radioterminals over a terrestrial wireless network frequency band.

48. A satellite radioterminal communications system according to claim 41 in combination with a terrestrial wireless network that is configured to communicate terrestrially with at least some of the plurality of first radioterminals over a terrestrial wireless network frequency band and over substantially the first air interface.

49. A radioterminal communications system comprising:
an ancillary terrestrial network that is configured to communicate with a plurality of first radioterminals in a plurality of first ancillary terrestrial network cells over substantially a first band segment of a first satellite frequency band and to communicate with a plurality of second radioterminals in a plurality of second ancillary terrestrial network cells over substantially a second band segment of the first and/or a second satellite frequency band.

50. A radioterminal communications system according to claim 49 wherein the ancillary terrestrial network is further configured to communicate with the plurality of first radioterminals in the plurality of first ancillary terrestrial network cells over a first air interface and to communicate with the plurality of second radioterminals in the plurality of second ancillary terrestrial network cells over a second air interface.

51. A radioterminal communications system according to claim 50 wherein the ancillary terrestrial network is further configured to communicate with the plurality of first radioterminals in the plurality of first ancillary terrestrial network cells using a first spectrum reuse cluster size and to communicate with the plurality of second radioterminals in the plurality of second ancillary terrestrial network cells using a second spectrum reuse cluster size.

52. A radioterminal communications system according to claim 50 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

53. A radioterminal communications system according to claim 51 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

54. A radioterminal communications system according to claim 49 wherein the ancillary terrestrial network is further configured to communicate with the plurality of first radioterminals in the plurality of first ancillary terrestrial network cells using a first spectrum reuse cluster size and to communicate with the plurality of second radioterminals in the plurality of second ancillary terrestrial network cells using a second spectrum reuse cluster size.

55. A radioterminal communications system according to claim 54 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

56. A radioterminal communications system according to claim 49 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

57. A radioterminal communications system according to claim 49 wherein the first and/or second satellite frequency band is an L-band and/or S-band.

58. A radioterminal communications system according to claim 49 wherein the plurality of first ancillary terrestrial network cells and the plurality of second ancillary terrestrial network cells at least partially overlap geographically.

59. A radioterminal communications system according to claim 51 wherein the first spectrum reuse cluster size and/or the second spectrum reuse cluster size is equal to one.

60. A radioterminal communications system according to claim 49 wherein the first band segment of the satellite frequency band and the second band segment of the satellite frequency band overlap partially but not fully.

61. A radioterminal communications system according to claim 49 wherein the plurality of first ancillary terrestrial network cells and the plurality of second ancillary terrestrial network cells are associated with respective first and second wireless network operators.

62. A radioterminal communications system according to claim 49 wherein the ancillary terrestrial network comprises a first ancillary terrestrial component that is configured to communicate-with at least some of the plurality of first radioterminals over substantially the first band segment of the satellite frequency band, and a second ancillary terrestrial component that is configured to communicate with at least some of a plurality of second radioterminals over substantially the second band segment of the satellite frequency band.

63. A radioterminal communications system according to claim 62 wherein the first ancillary terrestrial component is associated with a first wireless network operator and wherein the second ancillary terrestrial component is associated with a second wireless network operator.

64. A radioterminal communications system according to claim 49 in combination with a terrestrial wireless network that is configured to communicate terrestrially with at least some of the plurality of first radioterminals over a terrestrial wireless network frequency band.

65. A radioterminal communications system according to claim 50 in combination with a terrestrial wireless network that is configured to communicate terrestrially with at least some of the plurality of first radioterminals over a terrestrial wireless network frequency band and over substantially the first air interface.

66. A radioterminal communications system comprising:
an ancillary terrestrial network that is configured to communicate with a plurality of first radioterminals in a plurality of first ancillary terrestrial network cells using a first spectrum reuse cluster size and to communicate with a plurality of second radioterminals in a plurality of second ancillary terrestrial network cells using a second spectrum reuse cluster size.

67. A radioterminal communications system according to claim 66 wherein the ancillary terrestrial network is further configured to communicate with the plurality of first radioterminals in the plurality of first ancillary terrestrial network cells over a first air interface and to communicate with the plurality of second radioterminals in the plurality of second ancillary terrestrial network cells over a second air interface.

68. A radioterminal communications system according to claim 67 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

69. A radioterminal communications system according to claim 66 wherein the ancillary terrestrial network is further configured to communicate with the plurality of first radioterminals in the plurality of first ancillary terrestrial network cells having a first geographic cell size and to communicate with the plurality of second radioterminals in the plurality of second ancillary terrestrial network cells having a second geographic cell size.

70. A radioterminal communications system according to claim 66 wherein the plurality of first ancillary terrestrial network cells and the plurality of second ancillary terrestrial network cells at least partially overlap geographically.

71. A radioterminal communications system according to claim 66 wherein the first spectrum reuse cluster size or the second spectrum reuse cluster size is equal to one.

72. A radioterminal communications system according to claim 66 wherein the plurality of first ancillary terrestrial network cells and the plurality of second ancillary terrestrial network cells are associated with respective first and second wireless network operators.

73. A radioterminal communications system according to claim 66 in combination with a terrestrial wireless network that is configured to communicate terrestrially with at least some of the plurality of first radioterminals over a terrestrial wireless network frequency band.

74. A radioterminal communications system according to claim 67 in combination with a terrestrial wireless network that is configured to communicate terrestrially with at least some of the plurality of first radioterminals over a terrestrial wireless network frequency band and over substantially the first air interface.

75. A radioterminal communications system comprising:
an ancillary terrestrial network that is configured to communicate with a plurality of first radioterminals in a plurality of first ancillary terrestrial network cells having a first geographic cell size over a first air interface and to communicate with a plurality of second radioterminals in a plurality of second ancillary terrestrial network cells having a second geographic cell size over a second air interface.

76. A radioterminal communications system according to claim 75 wherein the plurality of first ancillary terrestrial network cells and the plurality of second ancillary terrestrial network cells at least partially overlap geographically.

77. A radioterminal communications system according to claim 75 wherein the plurality of first ancillary terrestrial network cells and the plurality of second ancillary terrestrial network cells are associated with respective first and second wireless network operators.

78. A radioterminal communications system according to claim 75 wherein the ancillary terrestrial network comprises a first ancillary terrestrial component that is configured to communicate with at least some of the plurality of first radioterminals over the first air interface, and a second ancillary terrestrial component that is configured to communicate with at least some of a plurality of second radioterminals over the second air interface.

79. A radioterminal communications system according to claim 78 wherein the first ancillary terrestrial component is associated with a first wireless network operator and wherein the second ancillary terrestrial component is associated with a second wireless network operator.

80. A radioterminal communications system according to claim 75 in combination with a terrestrial wireless network that is configured to communicate terrestrially with at least some of the plurality of first radioterminals over a terrestrial wireless network frequency band.

81. A radioterminal communications system according to claim 75 in combination with a terrestrial wireless network that is configured to communicate terrestrially with at least some of the plurality of first radioterminals over a terrestrial wireless network frequency band and over substantially the first air interface.

82. A satellite radioterminal communications method comprising:
communicating between a space-based component and a plurality of first radioterminals in a plurality of first satellite cells over a first band segment of a first satellite frequency band; and
communicating between the space-based component and a plurality of second radioterminals in a plurality of second satellite cells over a second band segment of the first and/or a second satellite frequency band.

83. A method according to claim 82 further comprising:
communicating between the space-based component and the plurality of first radioterminals in the plurality of first satellite cells over a first air interface; and
communicating between the space-based component and the plurality of second radioterminals in the plurality of second satellite cells over a second air interface.

84. A method according to claim 83 further comprising:
communicating between the space-based component and the plurality of first radioterminals in the plurality of first satellite cells using a first spectrum reuse cluster size; and
communicating between the space-based component and the plurality of second radioterminals in the plurality of second satellite cells using a second spectrum reuse cluster size.

85. A method according to claim 83 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

86. A method according to claim 84 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

87. A method according to claim 82 further comprising:
communicating between the space-based component and the plurality of first radioterminals in the plurality of first satellite cells using a first spectrum reuse cluster size; and
communicating between the space-based component and the plurality of second radioterminals in the plurality of second satellite cells using a second spectrum reuse cluster size.

88. A method according to claim 87 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

89. A method according to claim 82 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

90. A method according to claim 82 further comprising:
communicating terrestrially with at least some of the plurality of first radioterminals over substantially the first band segment of the satellite frequency band.

91. A method according to claim 83 further comprising:
communicating terrestrially with at least some of the plurality of first radioterminals over substantially the first air interface.

92. A method according to claim 84 further comprising:
communicating terrestrially with at least some of the plurality of first radioterminals in a plurality of first ancillary terrestrial network cells using a third spectrum reuse cluster size.

93. A method according to claim 82 further comprising:
communicating terrestrially with at least some of the plurality of first radioterminals over substantially the first band segment of the satellite frequency band and with at least some of the plurality of second radioterminals over substantially the second band segment of the satellite frequency band.

94. A method according to claim 83 further comprising:
communicating terrestrially with at least some of the plurality of first radioterminals over substantially the first air interface and with at least some of the plurality of second radioterminals over substantially the second air interface.

95. A method according to claim 84 further comprising:
communicating terrestrially with at least some of the plurality of first radioterminals in a plurality of first ancillary terrestrial network cells using a third spectrum reuse cluster size; and
communicating terrestrially with at least some of the plurality of second radioterminals in a plurality of second ancillary terrestrial network cells using a fourth spectrum reuse cluster size.

96. A method according to claim 82 wherein the first and/or second satellite frequency band is an L-band and/or S-band.

97. A method according to claim 82 wherein the plurality of first satellite cells and the plurality of second satellite cells at least partially overlap geographically.

98. A method according to claim 84 wherein the first spectrum reuse cluster size or the second spectrum reuse cluster size is equal to one.

99. A method according to claim 92 wherein the first spectrum reuse cluster size or the third spectrum reuse cluster size is equal to one.

100. A method according to claim 82 wherein the first band segment of the satellite frequency band and the second band segment of the satellite frequency band overlap partially but not fully.

101. A method according to claim 82 wherein the plurality of first satellite cells and the plurality of second satellite cells are associated with respective first and second wireless network operators.

102. A method according to claim 90 further comprising:
communicating terrestrially with at least some of the plurality of first radioterminals over a terrestrial wireless network frequency band.

103. A method according to claim 91 further comprising:
communicating terrestrially with at least some of the plurality of first radioterminals over a terrestrial wireless network frequency band and over substantially the first air interface.

104. A satellite radioterminal communications method comprising:
communicating between a space-based component and a plurality of first radioterminals in a plurality of first satellite cells using a first spectrum reuse cluster size; and
communicating between the space-based component and a plurality of second radioterminals in a plurality of second satellite cells using a second spectrum reuse cluster size.

105. A method according to claim 104 further comprising:
communicating between the space-based component and the plurality of first radioterminals in the plurality of first satellite cells over a first air interface; and
communicating between the space-based component and the plurality of second radioterminals in the plurality of second satellite cells over a second air interface.

106. A method according to claim 105 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

107. A method according to claim 104 further comprising:
communicating between the space-based component and the plurality of first radioterminals in the plurality of first satellite cells having a first geographic cell size; and
communicating between the space-based component and the plurality of second radioterminals in the plurality of second satellite cells having a second geographic cell size.

108. A method according to claim 104 further comprising:
communicating terrestrially with at least some of the plurality of first radioterminals in a plurality of first ancillary terrestrial network cells using a third spectrum reuse cluster size.

109. A method according to claim 105 further comprising:
communicating terrestrially with at least some of the plurality of first radioterminals over substantially the first air interface.

110. A method according to claim 104 further comprising:
communicating terrestrially with at least some of the plurality of first radioterminals in a plurality of first ancillary terrestrial network cells using a third spectrum reuse cluster size; and
communicating terrestrially with at least some of the plurality of second radioterminals in a plurality of second ancillary terrestrial network cells using a fourth spectrum reuse cluster size.

111. A method according to claim 105 further comprising:
communicating terrestrially with at least some of the plurality of first radioterminals over substantially the first air interface and with at least some of the plurality of second radioterminals over substantially the second air interface.

112. A method according to claim 93 wherein the plurality of first satellite cells and the plurality of second satellite cells at least partially overlap geographically.

113. A method according to claim 93 wherein the first spectrum reuse cluster size or the second spectrum reuse cluster size is equal to one.

114. A method according to claim 110 wherein the first spectrum reuse cluster size or the third spectrum reuse cluster size is equal to one.

115. A method according to claim 95 wherein the plurality of first satellite cells and the plurality of second satellite cells are associated with respective first and second wireless network operators.

116. A method according to claim 110 wherein the plurality of first satellite cells and the plurality of first ancillary terrestrial network cells are associated with a first wireless network operator and wherein the plurality of second satellite cells and the plurality of second ancillary terrestrial network cells are associated with a second wireless network operator.

117. A method according to claim 110 further comprising:
communicating terrestrially with at least some of the plurality of first radioterminals over a terrestrial wireless network frequency band.

118. A method according to claim 111 further comprising:
communicating terrestrially with at least some of the plurality of first radioterminals over a terrestrial wireless network frequency band and over substantially the first air interface.

119. A satellite radioterminal communications method comprising:
communicating between a space based component and a plurality of first radioterminals in a plurality of first satellite cells having a first geographic cell size over a first air interface; and
communicating between the space-based component and a plurality of second radioterminals in a plurality of second satellite cells having a second geographic cell size over a second air interface.

120. A method according to claim 119 further comprising:
communicating terrestrially with at least some of the plurality of first radioterminals over substantially the first air interface.

121. A method according to claim 119 further comprising:
communicating terrestrially with at least some of the plurality of first radioterminals over substantially the first air interface and with at least some of the plurality of second radioterminals over substantially the second air interface.

122. A method according to claim 119 wherein the plurality of first satellite cells and the plurality of second satellite cells at least partially overlap geographically.

123. A method according to claim 119 wherein the plurality of first satellite cells and the plurality of second satellite cells are associated with respective first and second wireless network operators.

124. A method according to claim 119 further comprising:
communicating terrestrially with at least some of the plurality of first radioterminals over a terrestrial wireless network frequency band.

125. A method according to claim 120 further comprising:
communicating terrestrially with at least some of the plurality of first radioterminals over a terrestrial wireless network frequency band and over substantially the first air interface.

126. A radioterminal communications method comprising:
communicating terrestrially with a plurality of first radioterminals in a plurality of first terrestrial cells over substantially a first band segment of a satellite frequency band; and
communicating terrestrially with a plurality of second radioterminals in a plurality of second terrestrial cells over substantially a second band segment of the same and/or different satellite frequency band.

127. A method according to claim 126 further comprising:
communicating terrestrially with the plurality of first radioterminals in the plurality of first terrestrial cells over a first air interface; and
communicating terrestrially with the plurality of second radioterminals in the plurality of second terrestrial cells over a second air interface.

128. A method according to claim 127 further comprising:
communicating terrestrially with the plurality of first radioterminals in the plurality of first terrestrial cells using a first spectrum reuse cluster size; and
communicating terrestrially with the plurality of second radioterminals in the plurality of second terrestrial cells using a second spectrum reuse cluster size.

129. A method according to claim 127 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

130. A method according to claim 128 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

131. A method according to claim 126 further comprising:
communicating terrestrially with the plurality of first radioterminals in the plurality of first terrestrial cells using a first spectrum reuse cluster size; and
communicating terrestrially with the plurality of second radioterminals in the plurality of second terrestrial cells using a second spectrum reuse cluster size.

132. A method according to claim 131 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

133. A method according to claim 126 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

134. A method according to claim 126 wherein the satellite frequency band is an L-band and/or S-band.

135. A method according to claim 126 wherein the plurality of first terrestrial cells and the plurality of second terrestrial cells at least partially overlap geographically.

136. A method according to claim 128 wherein the first spectrum reuse cluster size or the second spectrum reuse cluster size is equal to one.

137. A method according to claim 126 wherein the first band segment of the satellite frequency band and the second band segment of the satellite frequency band overlap partially but not fully.

138. A method according to claim 126 wherein the plurality of first terrestrial cells and the plurality of second terrestrial cells are associated with respective first and second wireless network operators.

139. A method according to claim 126 further comprising:
communicating terrestrially with at least some of the plurality of first radioterminals over a terrestrial wireless network frequency band.

140. A method according to claim 127 further comprising:
communicating terrestrially with at least some of the plurality of first radioterminals over a terrestrial wireless network frequency band and over substantially the first air interface.

141. A radioterminal communications method comprising:
communicating terrestrially with a plurality of first radioterminals in a plurality of first terrestrial cells using a first spectrum reuse cluster size; and
communicating with a plurality of second radioterminals in a plurality of second terrestrial cells using a second spectrum reuse cluster size.

142. A method to claim 141 further comprising:
communicating terrestrially with the plurality of first radioterminals in the plurality of first terrestrial cells over a first air interface; and
communicating terrestrially with the plurality of second radioterminals in the plurality of second terrestrial cells over a second air interface.

143. A method according to claim 142 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

144. A method according to claim 141 further comprising:
communicating terrestrially with the plurality of first radioterminals in the plurality of first terrestrial cells having a first geographic cell size; and
communicating terrestrially with the plurality of second radioterminals in the plurality of second terrestrial cells having a second geographic cell size.

145. A method according to claim 141 wherein the plurality of first terrestrial cells and the plurality of second terrestrial cells at least partially overlap geographically.

146. A method according to claim 141 wherein the first spectrum reuse cluster size or the second spectrum reuse cluster size is equal to one.

147. A method according to claim 141 wherein the plurality of first terrestrial cells and the plurality of second terrestrial cells are associated with respective first and second wireless network operators.

148. A method according to claim 141 further comprising:
communicating terrestrially with at least some of the plurality of first radioterminals over a terrestrial wireless network frequency band.

149. A method according to claim 142 further comprising:
communicating terrestrially with at least some of the plurality of first radioterminals over a terrestrial wireless network frequency band and over substantially the first air interface.

150. A radioterminal communications method comprising:
communicating terrestrially with a plurality of first radioterminals in a plurality of first terrestrial cells having a first geographic cell size over a first air interface; and
communicating terrestrially with a plurality of second radioterminals in a plurality of second terrestrial cells having a second geographic cell size over a second air interface.

151. A method according to claim 150 wherein the plurality of first terrestrial cells and the plurality of second terrestrial cells at least partially overlap geographically.

152. A method according to claim 150 wherein the plurality of first terrestrial cells and the plurality of second terrestrial cells are associated with respective first and second wireless network operators.

153. A method according to claim 150 further comprising:
communicating terrestrially with at least some of the plurality of first radioterminals over a terrestrial wireless network frequency band.

154. A method according to claim 150 further comprising:
communicating terrestrially with at least some of the plurality of first radioterminals over a terrestrial wireless network frequency band and over substantially the first air interface.

155. A satellite radioterminal communications system according to claim 1 wherein the plurality of first satellite cells do not overlap geographically with the plurality of second satellite cells.

156. A satellite radioterminal communications system according to claim 2 wherein the first air interface is the same or substantially the same as the second air interface.

157. A satellite radioterminal communications system according to claim 3 wherein the first spectrum reuse cluster size is the same as the second spectrum reuse cluster size.

158. A satellite radioterminal communications system according to claim 4 wherein the first geographic cell size is the same or substantially the same as the second geographic cell size.

159. A satellite radioterminal communications system according to claim 11 wherein the third spectrum reuse cluster size is the same as the first spectrum reuse cluster size.

160. A satellite radioterminal communications system according to claim 14 wherein the third spectrum reuse cluster size is the same as the fourth spectrum reuse cluster size.

161. A satellite radioterminal communications system according to claim 75 wherein the first air interface is the same or substantially the same as the second air interface.
